(19) United States
(12) Patent Application Publication
(10) Pub. No.: US 2026/0163515 A1
(43) Pub. Date: Jun. 11, 2026

(54) DRIVE DEVICE

(71) Applicant: TOYOTA JIDOSHA KABUSHIKI KAISHA, Toyota-shi (JP)

(72) Inventor: Junya HASEBE, Toyota-shi (JP)

(73) Assignee: TOYOTA JIDOSHA KABUSHIKI KAISHA, Toyota-shi (JP)

(21) Appl. No.: 19/408,775

(22) Filed: Dec. 4, 2025

(30) Foreign Application Priority Data
Dec. 5, 2024 (JP) 2024-211931

(51) Int. Cl. H02P 29/62; B60L 50/64; B60L 58/27; H01M 10/615; H01M 10/625; H01M 10/633

(52) U.S. Cl. CPC H02P 29/62; H01M 10/615; H01M 10/625; H01M 10/633; B60L 50/64; B60L 58/27; H01M 2220/20

(57) ABSTRACT

When heat generation control for heating a battery is performed by outputting zero torque from a motor in a state where rotation of a rotor is stopped, an electrical lead angle is set to +90 degE or −90 degE and a current frequency is set in order to make output torque of the motor zero, and switching control of switching elements of an inverter is performed by current feedback control so as to provide the set electrical lead angle and the current frequency.

### CROSS-REFERENCE TO RELATED APPLICATIONS

The present disclosure claims priority to Japanese Patent Application No. 2024-211931 filed Dec. 5, 2024, which is incorporated herein by reference in its entirety including specification, drawings and claims.

### TECHNICAL FIELD

The present disclosure relates to a drive device, and more particularly to a drive device including a motor, an inverter, and a battery.

### BACKGROUND

Conventionally, as the drive device of this type, there has been proposed the device in which the lubricating oil is warmed by the heat generation due to the copper loss of the coil and the heat generation due to the iron loss of the core of the motor by energizing the current of the electrical lead angle at which the output torque of the motor becomes zero torque before starting (see, for example, Japanese Patent Application Laid Open No. 2011-089625). In this device, as the current of the electrical lead angle at which the output torque becomes zero torque, a first current in which the electrical lead angle is +90 degE and a second current in which the electrical lead angle is −90 degE are alternately supplied to the coils of the motor.

### SUMMARY

However, in the above-described drive device, since the first current in which the electrical lead angle is +90 degE and the second current in which the electrical lead angle is −90 degE are alternately supplied to the coils of the motor, the flux variation in the magnetic path of the motor becomes large, the heat generation from the iron loss becomes significant, and thermal demagnetization may occur in the magnets attached to the rotor. Further, when the rotor is not rotating, current flows through a specific phase coil of the three-phase coils, and damage to the coil due to the temperature rise may occur.

The drive device of the present disclosure has the primary purpose of causing the current to flow evenly through the three-phase coils of the motor in a state where the rotor is not rotating.

The drive device of the present disclosure has adopted the following measures in order to achieve the above primary purpose.

The drive device of the present disclosure comprises:
a motor including a rotor with permanent magnets and three-phase coils of a stator connected in a star connection;
an inverter for driving the motor;
a battery for supplying direct-current power to the inverter; and
a control unit programmed to receive an electrical lead angle and a current frequency and to perform switching control of switching elements of the inverter by current feedback control;
wherein, when the heat generation control for heating the battery by outputting zero torque from the motor with rotation of the rotor being stopped is performed, the control unit is programmed to set the electrical lead angle to +90 degE or −90 degE and to set the current frequency to make output torque of the motor zero, and is programmed to perform the switching control of the switching elements of the inverter by the current feedback control so as to provide the set electrical lead angle and the current frequency.

In the drive device of the present disclosure, when the heat generation control is performed, the electrical lead angle is set to +90 degE or −90 degE and the current frequency is set in order to make the output torque of the motor zero, and the switching control of the switching elements of the inverter is performed by the current feedback control so as to provide the set electrical lead angle and the current frequency. As a result, it is possible to make the output torque of the motor zero and to cause the current to flow evenly through the three-phase coils. Consequently, the disadvantages caused by allowing a large current to flow only through a specific phase coil, for example, the thermal demagnetization of magnets attached to the rotor or the damage to the specific phase coil, can be suppressed. Naturally, the battery can be heated while the output torque of the motor is made zero.

### BRIEF DESCRIPTION OF DRAWINGS

FIG. 1 is a configuration diagram showing an outline of a configuration of an electric vehicle 20 equipped with a drive device according to an embodiment of the present disclosure;

FIG. 2 is a flowchart showing one example of heat generation control process executed by an electronic control unit 50;

FIG. 3 is an explanatory diagram showing one example of output torque from a motor 32 for one electrical cycle when performing zero torque output in the heat generation control of the motor 32, and

FIG. 4 is an explanatory diagram showing one example of relationship between an electrical lead angle θ of a current of the motor 32 and torque.

### DESCRIPTION OF EMBODIMENTS

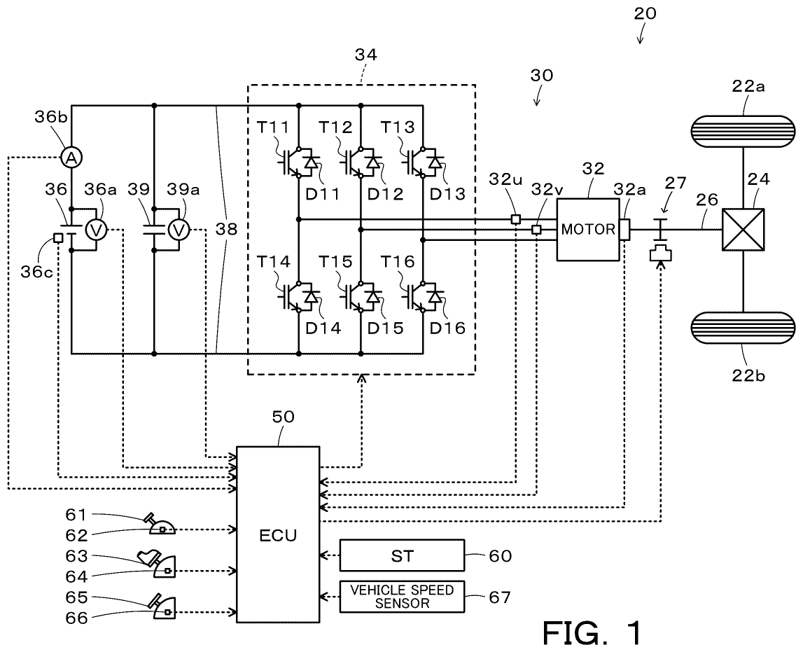

Next, an embodiment (mode for carrying out the disclosure) for implementing the present disclosure will be described. FIG. 1 is the configuration diagram schematically showing the configuration of the electric vehicle 20 equipped with a drive device 30 according to the embodiment of the present disclosure. As illustrated, the electric vehicle 20 of the embodiment comprises the motor 32 for driving the vehicle, an inverter 34, a battery 36, and an electronic control unit 50.

The motor 32 for driving the vehicle is configured as the well-known permanent magnet synchronous motor-generator comprising the rotor in which the permanent magnets are embedded in the rotor core, and the stator in which the three-phase coils connected in the star connection are wound around the stator core. The rotor of the motor 32 is connected to a drive shaft 26, which is coupled to drive wheels 22a and 22b via a differential gear 24.

The inverter 34 is used for driving the motor 32 for driving the vehicle. The inverter 34 is connected to the battery 36 through a power line 38, and includes six transistors T11 to T16 as the switching elements and six diodes D11 to D16 respectively connected in parallel with the six transistors T11 to T16. The transistors T11 to T16 are arranged in pairs such that each pair comprises two transistors respectively serving as the source side and the sink side with respect to the positive-side line and the negative-side line of the power line 38. Each connection point of each pair of the two transistors is connected to the coil of the corresponding phase (U-phase, V-phase, W-phase) of the motor 32. Therefore, when the voltage is applied to the inverter 34, by adjusting the ratio of the on-time of the paired transistors T11 to T16 by the electronic control unit 50, the rotating magnetic field is formed in the three-phase coils, and the motor 32 is rotationally driven.

The battery 36 is configured as a lithium-ion secondary battery or a nickel-metal hydride secondary battery, and is connected to the inverter 34 through the power line 38. A smoothing capacitor 39 is attached to the power line 38.

An electric parking brake 27 is attached to the drive shaft 26, and is activated when a shift lever 61 is set from the non-parking position (a position other than the P-position) to the parking position (the P-position), and is released when the shift lever 61 is set from the parking position to the non-parking position.

The electronic control unit 50 is configured as a microcomputer including CPU, ROM, RAM, flash memory, and input/output port. The electronic control unit 50 receives as inputs a rotation position θm of the rotor of the motor 32 from a rotation position sensor 32a, phase currents Iu and Iv of the U-phase and the V-phase of the motor 32 from current sensors 32u and 32v, a voltage Vb of the battery 36 from a voltage sensor 36a, a current Ib of the battery 36 from a current sensor 36b, temperature Tb of the battery 36 from a temperature sensor 36c, and a voltage VL of the power line 38 (the capacitor 39) from a voltage sensor 39a. The electronic control unit 50 also receives as inputs a start signal from a start switch 60, a shift position SP representing an operation position of the shift lever 61 from a shift position sensor 62, an accelerator opening degree Acc representing a depression amount of an accelerator pedal 63 from an accelerator pedal sensor 64, a brake pedal position BP representing a depression amount of a brake pedal 65 from a brake pedal sensor 66, and a vehicle speed V from a vehicle speed sensor 67.

The electronic control unit 50 outputs switching control signals for switching the transistors T11 to T16 of the inverter 34 and the drive control signal for the electric parking brake 27. The electronic control unit 50 calculates an electrical angle θe and a rotational speed Nm of the motor 32 based on the rotation position θm, and estimates output torque Tm of the motor 32 based on the phase currents Iu and Iv and the electrical angle θe. The estimation of the output torque Tm is performed, for example, by assuming that the sum of the currents of each phase of the motor 32 is zero, transforming the phase currents Iu and Iv of the U-phase and the V-phase into a d-axis current Id and a q-axis current Iq by using the electrical angle θe of the motor 32 through the coordinate transformation (three-phase/two-phase transformation), and deriving the output torque Tm by applying the d-axis current Id and the q-axis current Iq to the predetermined relationship between the currents Id and Iq and the output torque Tm.

In the electric vehicle 20 of the embodiment, the electronic control unit 50 sets a traveling request torque Td* (the torque requested for the drive shaft 26) required for traveling as a torque command Tm* of the motor 32, and controls the transistors T11 to T16 of the inverter 34 such that the motor 32 is driven with the torque command Tm*. Here, the traveling request torque Td* is set based on the accelerator opening degree Acc and the vehicle speed V. The control of the inverter 34 is performed, for example, by pulse width modulation (PWM) control.

In the PWM control, first, by assuming that the sum of the currents of each phase of the motor 32 is zero, the phase currents Iu and Iv of the U-phase and the V-phase of the motor 32 are transformed into the d-axis current Id and the q-axis current Iq by using the electrical angle θe of the motor 32 through the coordinate transformation (three-phase/two-phase transformation). Subsequently, based on the torque command Tm*, current commands Id* and Iq* of the d-axis and the q-axis are set, and voltage commands Vd* and Vq* of the d-axis and the q-axis are calculated such that the differences between the current commands Id* and Iq* and the currents Id and Iq are canceled. Then, by using the electrical angle θe of the motor 32, the voltage commands Vd* and Vq* of the d-axis and the q-axis are transformed into voltage commands Vu*, Vv*, and Vw* of each phase through the coordinate transformation (two-phase/three-phase transformation), and the PWM signals of the transistors T11 to T16 are generated by comparing these voltage commands Vu*, Vv*, and Vw* with a carrier wave voltage, thereby performing the switching control of the transistors T11 to T16.

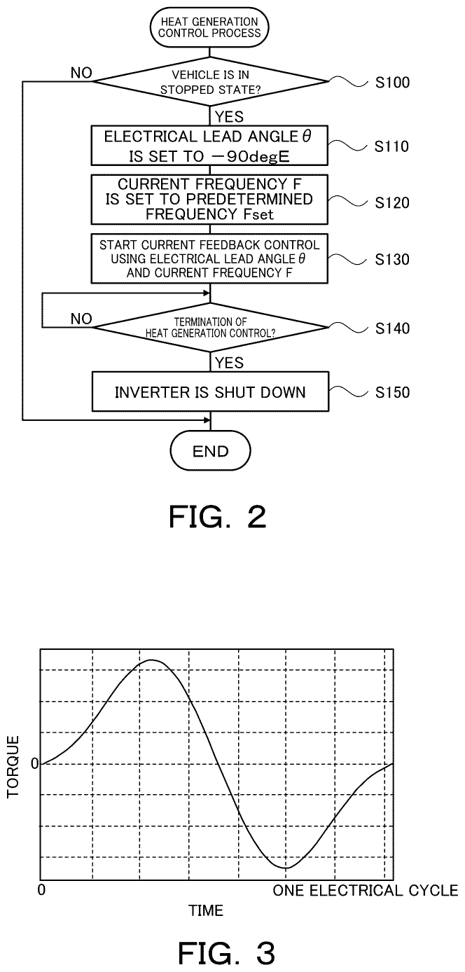

Next, the operation of the electric vehicle 20 of the embodiment, in particular, the operation when performing the heat generation control for heating the battery 36 by outputting zero torque from the motor 32 in a state where the rotation of the rotor of the motor 32 is stopped, will be described. FIG. 2 is the flowchart showing one example of the heat generation control process executed by the electronic control unit 50.

When the heat generation control process is executed, the electronic control unit 50 first determines whether the vehicle is in the stopped state (step S100). This determination is whether the stopped state can be maintained even if a slight torque is output from the motor 32. For example, it is determined that the vehicle is in the stopped state when the electric parking brake 27 is turned on, or when the vehicle speed V is zero and the brake pedal 65 is depressed with sufficient pedal force. FIG. 3 shows one example of the output torque of the motor 32 for one electrical cycle when performing the zero torque output in the heat generation control of the motor 32. As shown in FIG. 3, the zero torque output in the heat generation control of the motor 32 means that the total torque output for one electrical cycle is zero torque output, while slight torque output is generated in the positive direction and the negative direction within one electrical cycle. Therefore, it is necessary that the stopped state can be maintained even if a slight torque is output from the motor 32. In step S100, it is determined whether such maintenance of the stopped state is possible. When it is determined in step S100 that the vehicle is not in the stopped state, it is judged that the heat generation control of the motor 32 should not be performed, and this process is terminated.

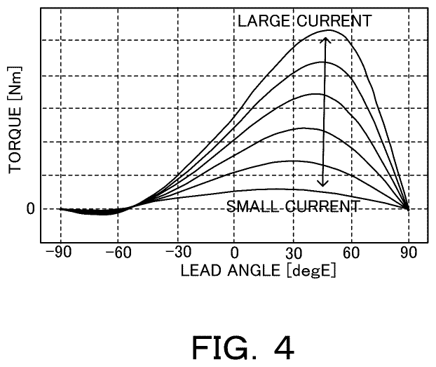

When it is determined in step S100 that the vehicle is in the stopped state, the electrical lead angle θ is set to −90 degE (step S110), a current frequency F is set to the predetermined frequency Fset (step S120), and the heat generation control of the motor 32 is started by starting the switching control of the transistors T11 to T16 of the inverter 34 by the current feedback control using the set electrical lead angle θ and the current frequency F (step S130). The reason for setting the electrical lead angle θ to −90 degE is to reduce the torque output from the motor 32 when a slight deviation occurs in the electrical lead angle θ from the set value due to the current feedback control, compared with the electrical lead angle θ of +90 degE, which is the electrical lead angle for performing the zero torque output from the motor 32. FIG. 4 shows one example of the relationship between the lead angle of the current of the motor 32 and the torque. As shown, the torque in the vicinity of the electrical lead angle θ of −90 degE is smaller than the torque in the vicinity of the electrical lead angle θ of +90 degE. That is, the rate of change of the torque with respect to the electrical lead angle in the vicinity of the electrical lead angle θ of −90 degE is smaller than the rate of change of the torque with respect to the electrical lead angle in the vicinity of the electrical lead angle θ of +90 degE. Therefore, when the current feedback control is performed with the electrical lead angle θ set to −90 degE, the output torque from the motor 32 with respect to the deviation of the electrical lead angle θ during the current feedback control can be made smaller than when the current feedback control is performed with the electrical lead angle θ set to +90 degE. The predetermined frequency Fset may be any frequency equal to or less than the upper limit frequency obtained by converting the upper limit rotational speed of the motor 32, at which the PWM control can be performed by the inverter 34, into the frequency. For example, a frequency approximately one-half of the upper limit frequency may be used. When the heat generation control of the motor 32 is started, the three-phase alternating current having the electrical lead angle θ of −90 degE and the current frequency F of the predetermined frequency Fset flows through the three-phase coils of the motor 32, thereby heating the battery 36 by the zero torque output of the motor 32.

Such heat generation control of the motor 32 is performed until the termination of the heat generation control is determined (step S140). When the termination of the heat generation control is determined, the inverter 34 is shut down (step S150), and this process is terminated. The termination of the heat generation control is performed when the temperature of the battery 36 reaches the temperature suitable for charging.

In the drive device 30 of the embodiment described above, after confirming that the vehicle is in the stopped state, the electrical lead angle θ is set to −90 degE and the current frequency F is set to the predetermined frequency Fset, and the heat generation control of the motor 32 is started by starting the switching control of the transistors T11 to T16 of the inverter 34 by the current feedback control using the set electrical lead angle θ and the current frequency F. In such heat generation control of the motor 32, since the three-phase alternating current having the electrical lead angle θ of −90 degE and the current frequency F of the predetermined frequency Fset flows through the three-phase coils of the motor 32, it is possible to suppress the current from flowing only through a specific phase coil, and thereby suppress disadvantages caused by the current flowing only through the specific phase coil, for example, suppressing damage to the permanent magnets attached to the rotor of the motor 32 or to the three-phase coils.

In the drive device 30 of the embodiment, since the heat generation control of the motor 32 is performed by the current feedback control with the electrical lead angle θ set to −90 degE, the output torque from the motor 32 with respect to the deviation of the electrical lead angle θ during the current feedback control can be reduced as compared with when the heat generation control of the motor 32 is performed by the current feedback control with the electrical lead angle θ set to +90 degE. It should be noted that if the current flowing during the heat generation control of the motor 32 is reduced, the output torque from the motor 32 with respect to the deviation of the electrical lead angle θ during the current feedback control is also reduced. Therefore, the heat generation control of the motor 32 may be performed by the current feedback control with the electrical lead angle θ set to +90 degE.

In the embodiment, the drive device 30 is mounted on the electric vehicle 20. However, the drive device 30 may be mounted on a hybrid vehicle, or may be mounted on a fuel cell vehicle. Further, the drive device 30 may also be configured not to be mounted on a vehicle.

In the drive device of the present disclosure, the control unit may be programmed to set the electrical lead angle to −90 degE when performing the heat generation control. In this way, even if a slight deviation occurs from the intended −90 degE in the electrical lead angle while the switching elements of the inverter are being controlled by the current feedback control, the torque output from the motor can be made small. This is based on the fact that, in the current-torque characteristic of the motor, the torque in the vicinity of −90 degE of the electrical lead angle is smaller than the torque in the vicinity of +90 degE of the electrical lead angle.

In the drive device of the present disclosure, the control unit may be programmed to set the current frequency within a range in which the PWM control is possible when performing the heat generation control. In this way, the three-phase alternating current can be applied to the three-phase coils of the motor, and the unexpected torque output from the motor can be suppressed.

In the drive device of the present disclosure, the drive device may include a fixing member that fixes the rotor so as not to rotate, and the control unit may be programmed to fix the rotor so as not to rotate by the fixing member when performing the heat generation control. In this way, even if the output torque is zero in terms of the electrical cycle, the rotation of the rotor caused by the torque generated within the cycle can be suppressed. Here, examples of the fixing member include those that fix a rotary shaft connected to the rotor, and those that fix another shaft mechanically connected to this rotary shaft. For example, when the rotor of the motor is connected to the drive shaft of a vehicle on which the drive device is mounted, the fixing member may include a parking gear for mechanically fixing the drive shaft or a hydraulic brake for fixing the rotation of the drive wheels connected to the drive shaft.

The correspondence between the main elements of the embodiment and the main elements of the disclosure described in Summary will be explained. In the embodiment, the motor 32 corresponds to “the motor,” the inverter 34 corresponds to “the inverter,” the battery 36 corresponds to “the battery,” and the electronic control unit 50 corresponds to “the control unit.”

The correspondence between the major elements of the embodiment and the major elements of the disclosure described in Summary is an example of how the embodiment can be used to specifically explain the embodiment of the disclosure described in Summary. This does not limit the elements of the disclosure described in Summary. In other words, interpretation of the disclosure described in Summary should be based on the description in that section, and the embodiment is only one specific example of the disclosure described in Summary.

The present disclosure has been described above using the embodiment, but the present disclosure is not limited to such embodiment, and it is of course possible to implement the present disclosure in various forms within the scope not departing from the gist of the present disclosure.

### INDUSTRIAL APPLICABILITY

The present disclosure is applicable to the manufacturing industry of the drive device and the like.

1. A drive device comprising:
a motor including a rotor with permanent magnets and three-phase coils of a stator connected in a star connection;
an inverter for driving the motor;
a battery for supplying direct-current power to the inverter; and
a control unit programmed to receive an electrical lead angle and a current frequency and to perform switching control of switching elements of the inverter by current feedback control;
wherein, when heat generation control for heating the battery by outputting zero torque from the motor with rotation of the rotor being stopped is performed, the control unit is programmed to set the electrical lead angle to +90 degE or −90 degE and to set the current frequency to make output torque of the motor zero, and is programmed to perform the switching control of the switching elements of the inverter by the current feedback control so as to provide the set electrical lead angle and the current frequency.

2. The drive device according to claim 1,
wherein the control unit is programmed to set the electrical lead angle to −90 degE when performing the heat generation control.

3. The drive device according to claim 1,
wherein the control unit is programmed to set the current frequency within a range in which PWM control is possible when performing the heat generation control.

4. The drive device according to claim 1,
further comprising a fixing member that fixes the rotor so as not to rotate,
wherein the control unit is programmed to fix the rotor by the fixing member so as not to rotate when performing the heat generation control.

5. The drive device according to claim 2,
further comprising a fixing member that fixes the rotor so as not to rotate,
wherein the control unit is programmed to fix the rotor by the fixing member so as not to rotate when performing the heat generation control.

6. The drive device according to claim 3,
further comprising a fixing member that fixes the rotor so as not to rotate,
wherein the control unit is programmed to fix the rotor by the fixing member so as not to rotate when performing the heat generation control.
